(19) United States
(12) Patent Application Publication
(10) Pub. No.: US 2008/0034546 A1
(43) Pub. Date: Feb. 14, 2008

(54) Rotatable hinge

(76) Inventor: Jia-Hao Hsu, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/483,060

(22) Filed: Jul. 10, 2006

(51) Int. Cl. E05D 3/10

(52) U.S. Cl. 16/367

(57) ABSTRACT

A rotatable hinge has a lower bracket, an upper bracket, a pivot shaft and a pivot pin. The upper bracket is mounted above the upper bracket and has a connecting wall formed on the upper bracket and has a riveting hole. The pivot shaft is mounted with the upper bracket and the lower bracket and has an enlarged end mounted on the upper bracket. The pivot pin rotatably extends through the riveting hole and has a limit mounted securely around the pivot pintle. The limit has a protruding section to control the cover to be rotatable at a specific angle.

### BACKGROUND OF THE INVENTION

1. Field of Invention

The present invention relates to a rotatable hinge, and more particularly to a rotatable hinge being able to rotate when an angle between a base and a cover is at a specific angle.

2. Description of the Related Art

An electronic appliance such as a laptop or a mobile phone has a base, a cover and a hinge. The cover connects with the base and may have a camera lens. A hinge is usually mounted between the base and the cover, which pivots to open or close the cover and rotates the cover relative to the base, so the camera lens on the cover is able to rotate and to face different directions.

However, the cover is unable to be rotated relative to the base when an angle between the cover and the base is smaller than 90°. A conventional hinge can not limit the cover to rotate relative to the base before the angle between the cover and the base is at least 90°. Another conventional hinge for solving the problem above is rotatable at any angle even when the cover is not opened. If the cover is not opened and is mounted on the base, a rotation of the cover relative to the base will cause the cover and the base to be worn off each other.

To overcome the shortcomings, the present invention provides a rotatable hinge to mitigate or obviate the aforementioned.

### SUMMARY OF THE INVENTION

The primary objective of the present invention is to provide a rotatable hinge being able to rotate when an angle between a base and a cover is at a specific angle.

To achieve the objective, a rotatable hinge has a lower bracket with a central hole, an upper bracket, a pivot shaft and a pivot pin. The upper bracket is mounted above the upper bracket and has two sides, a central circular hole and a connecting wall. The connecting wall formed perpendicularly on one side of the upper bracket and has a riveting hole. The pivot shaft is mounted through the central hole and the central circular hole and has an enlarged end mounted on the upper surface of the upper bracket. The pivot pin rotatably extends through the riveting hole of the connecting wall and has a limit mounted securely around the pivot pintle. The limit has a protruding section to control the cover to be rotatable at a specific angle.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a rotatable hinge in accordance with the present invention when an upper bracket is unable to rotate relative to a lower bracket;

FIG. 2 is an exploded perspective view of the rotatable hinge in FIG. 1;

FIG. 3 is an enlarged operational side view in partial protruding section of the rotatable hinge in FIG. 1 when the upper bracket is able to rotate relative to the lower bracket (solid line) and when the upper bracket is unable to rotate relative to the lower bracket (dotted line);

FIG. 4 is a perspective view of another embodiment of a rotatable hinge in accordance with the present invention when an upper bracket enables to rotate relative to a lower bracket;

FIG. 5 is a perspective view of the rotatable hinge in FIG. 4 when the upper bracket is able to rotate relative to the lower bracket;

FIG. 6 is a front view of the rotatable hinge in FIG. 4 when the upper bracket is unable to rotate relative to the lower bracket;

FIG. 7 is a front view of the rotatable hinge in FIG. 4 when the upper bracket is able to rotate relative to the lower bracket;

FIG. 8 is an operational perspective view of a rotatable hinge in accordance with the present invention mounted in a laptop with a cover and a base.

FIG. 9 is an operational top view of a rotatable hinge with a limiting protrusion on the upper bracket contacting a limiting tab on the limiting ring when an upper bracket rotates clockwise;

FIG. 10 is an operational perspective top view of the rotatable hinge in FIG. 9 with the limiting tab limited by one protrusion on the fastening ring when the upper bracket rotates clockwise;

FIG. 11 is an operational top view of the rotatable hinge with a limiting protrusion contacting a limiting tab when an upper bracket rotates counter-clockwise; and

FIG. 12 is an operational perspective top view of the rotatable hinge in FIG. 11 with the limiting tab limited by the other protrusion on the fastening ring when the upper bracket rotates counter-clockwise.

### DETAILED DESCRIPTION OF THE INVENTION

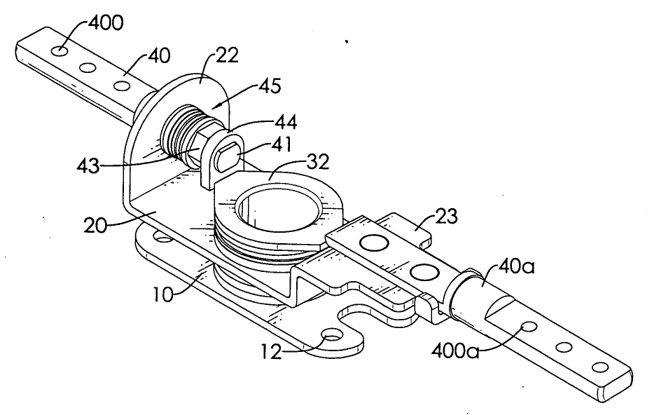

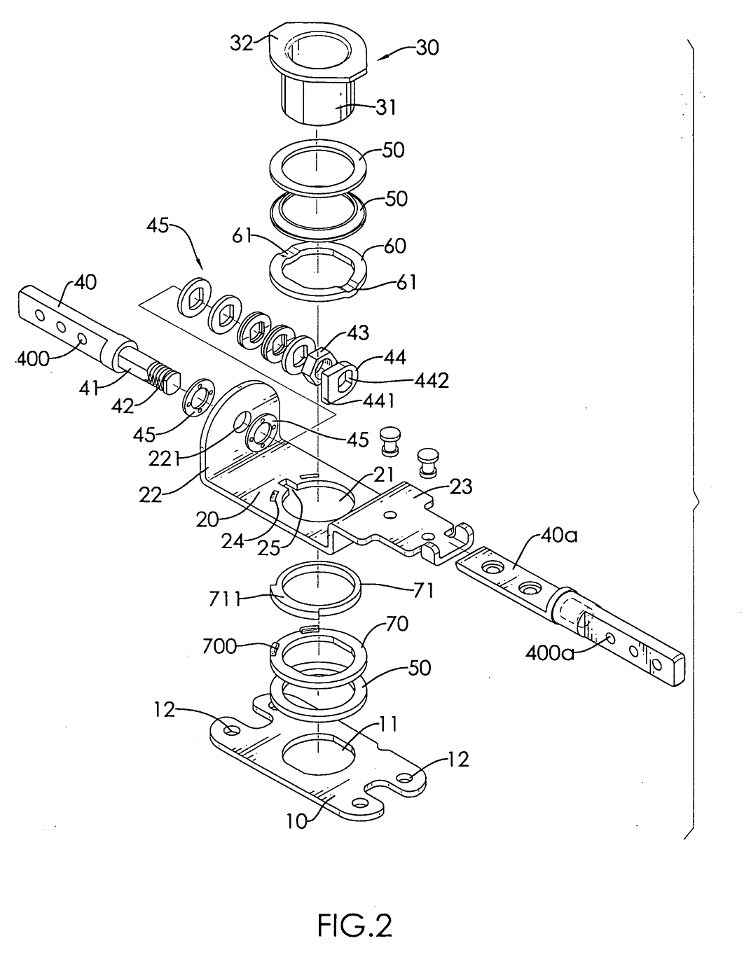

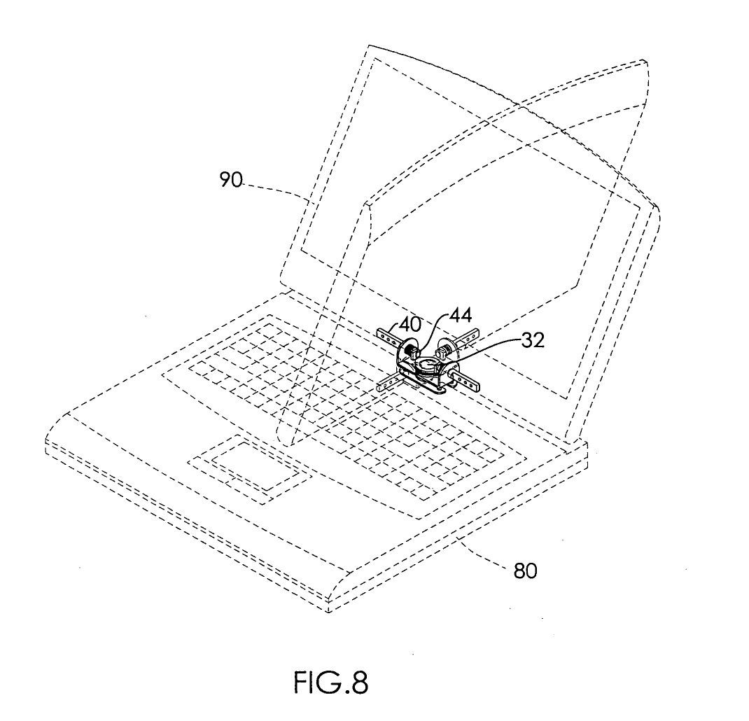

With reference to FIGS. 1, 2 and 8, a rotatable hinge in accordance with the present invention mounted in an electronic appliance with a base (80) and a cover (90) has a lower bracket (10), an upper bracket (20), a pivot shaft (30), multiple large annular washers (50), a pivot pin (40), an assistant pivot pin (40a), a positioning ring (60), a limiting ring (71) and a fastening ring (70).

The lower bracket (10) connects securely with the base (80) and has a central hole (11) and multiple threaded holes (12). The central hole (11) and threaded holes (12) are defined through the lower bracket (10). The threaded holes (12) allow the lower bracket (10) to connect securely with the base (80) by screws.

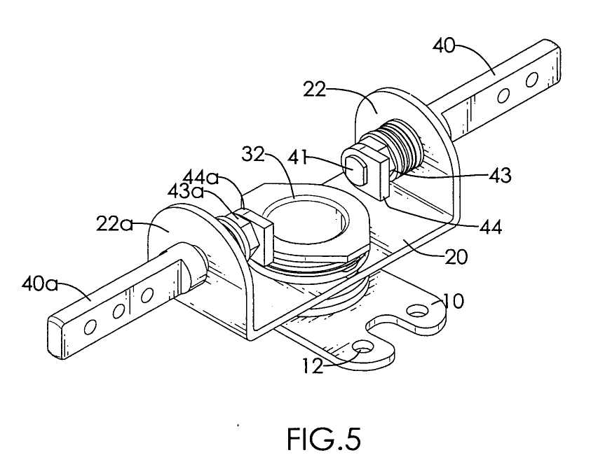

With further reference to FIG. 5, the upper bracket (20) is mounted above the lower bracket (10) and has an upper surface, a bottom surface, two sides, a central circular hole (21), multiple positioning slots (25), two limiting protrusions (24), a connecting wall (22) and an assistant connecting wall (23). The central circular hole (21) is defined through the upper bracket (20) and corresponds to the central hole (11) of the lower bracket (10). The positioning slots (25) are respectively formed in the upper bracket (20) and communicates with the central circular hole (21). The limiting protrusions (24) protrude from the bottom surface of the upper bracket (20) and are arranged in a circle being concentric with the central circular hole (21). The connecting wall (22) is formed perpendicularly on one side of the upper bracket (20) and has an inner surface, an outer surface and a through hole (221). The assistant connecting wall (23) is formed perpendicularly on the other side of the upper bracket (20). The assistant connecting wall (23) may be L-shaped and may have an assistant riveting hole. The assistant connecting wall (23) may be the same with the connecting wall (22) and may have a riveting hole corresponding to the riveting hole in the connecting wall (22).

The pivot shaft (30) is mounted through the central hole (11) of the lower bracket (10) and the central circular hole (21) of the upper bracket (20) and has a body (31) and an enlarged end (32). The body (31) protrudes through the central hole (11) of the lower bracket (10) and the central circular hole (21) of the upper bracket (20) to allow the lower bracket (10) to be mounted securely around the body (31) and to allow the upper bracket (20) to be mounted rotatably around the body (31). The enlarged end (32) is oval-shaped, abuts the upper surface of the upper bracket (20).

The first annular washers (50) are mounted around the pivot shaft (30), at least one first annular washer (50) is mounted between the lower bracket (10) and the upper bracket (20) and the rest of the first annular washers (50) is mounted between the enlarged end (32) of the pivot shaft (30) and the upper bracket (20) to increase an area providing friction.

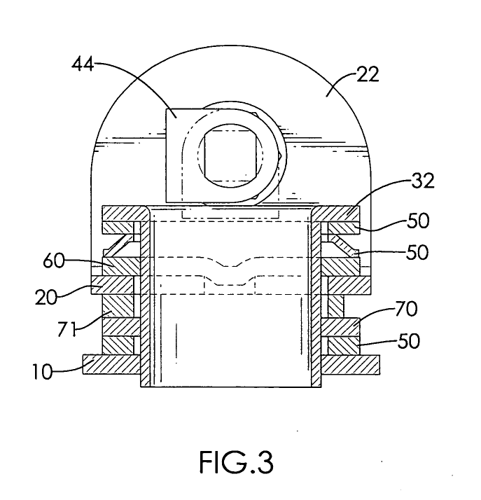

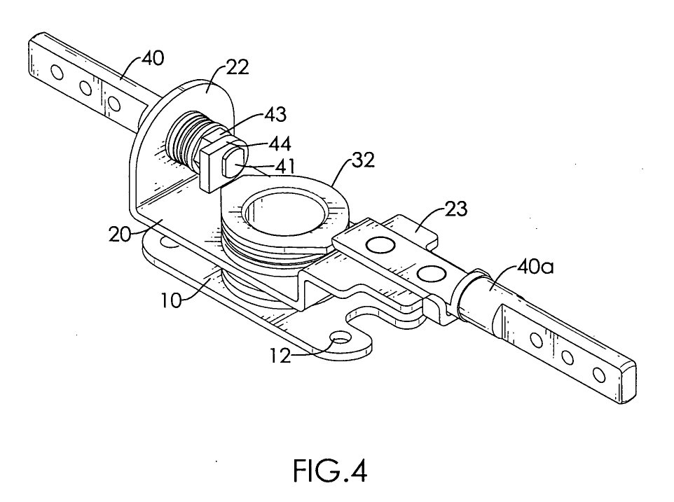

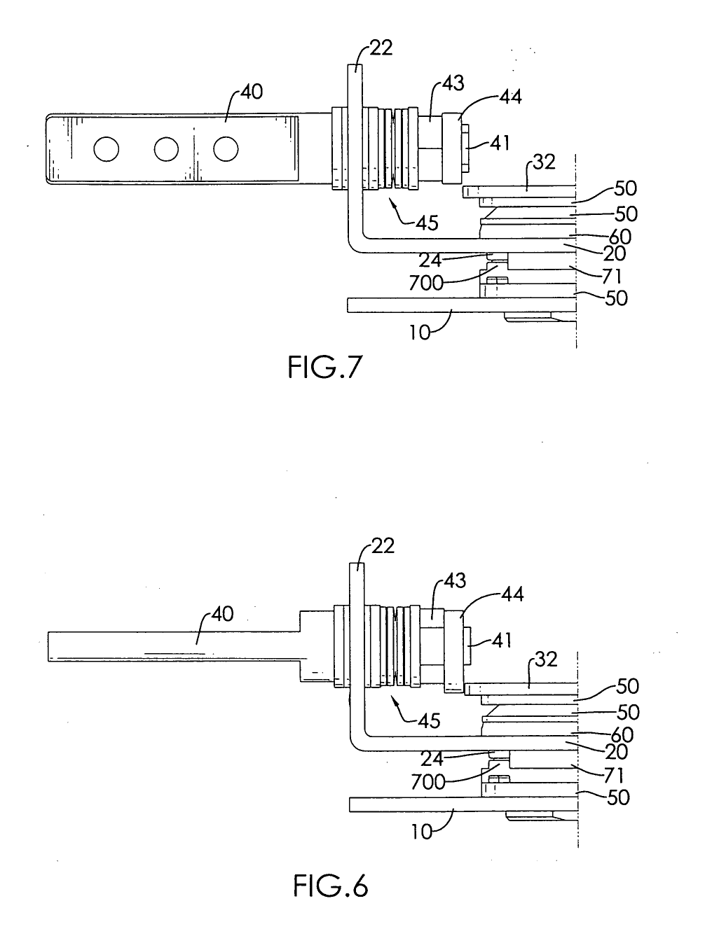

With further reference to FIGS. 3, 5 to 7, the pivot pin (40) is mounted securely to the cover (90), rotatably extends through the through hole (221) of the connecting wall (22) and has multiple threaded holes (400), a protruding pintle (41.), multiple second annular washers (45), a nut (43) and a limit (44). The threaded holes (400) allow the pivot pin (40) to connect securely with the cover (90) by screws. The protruding pintle (41) rotatably extends through the through hole (221) of the connecting wall (22) and has an end and an outer thread (42). The outer thread (42) is formed around the end of the protruding pintle (41). The second annular washers (45) are mounted around the protruding pintle (41) and are respectively mounted adjacent to the inner surface or the outer surface of the connecting wall (22) to increase an area providing friction. Therefore, the friction between the connecting wall (22) and the second annular washers (45) holds the cover (90) easily at any desired angle. The nut (43) is mounted around the protruding pintle (41) and has an inner thread screwing with the protruding pintle (41) to allow the second annular washers (45) to be fastened between the nut (43) and the inner surface of the connecting wall (22). The limit (44) is mounted securely around the protruding pintle (41) and has a protruding section. The protruding section of limit (44) is lower than and locks the enlarged end (32) of the pivot shaft (30) at least when the cover is closed. A shape of the protruding section controls when the cover (90) is rotatable relative to the base (80). In the embodiment, the protruding section has a lower end (441) and the limit further has an upper end apposite to the lower end of the protruding section, two sides, a riveting hole (442), a length between the upper end and the riveting hole (442), two lengths between the sides and the riveting hole (442) and a length between the lower end (441) and the riveting hole (442). The protruding section in this embodiment is the lower end (441). The lower end (441) is lower than and locks the enlarged end (32) of the pivot shaft (30) when the lower end (411) faces the upper surface of the upper bracket (20) and an angle between the base (80) and the cover (90) is smaller than 90°, so the upper bracket (20) is unable to rotate relative to the lower bracket (10). The lower end (441) does not face the upper surface of the upper bracket (20) when the angle between the base (80) and the cover (90) is at least 90°. The upper end is higher than the enlarged end (32) of the pivot shaft (30) when the upper end faces the upper surface of the upper bracket (20) and the angle between the base (80) and the cover (90) is at least 180°, so the upper bracket (20) is able to rotate relative to the lower bracket (10). The sides are higher than the enlarged end (32) of the pivot shaft (30) when one of the sides faces the upper surface of the upper bracket (20) and the angle between the base (80) and the cover (90) is at least 90°, so the upper bracket (20) is able to rotate relative to the lower bracket (10). The riveting hole (442) allows the protruding pintle (41) securely to protrude through the riveting hole (442). The length between the lower end and the riveting hole (442) is longer than the length between the upper end and the riveting hole (442) and two lengths between the sides and the riveting hole (442).

The assistant pivot pin (40a) connects to the assistant connecting wall (23), is attached to the cover (90) and has multiple assistant threaded holes (400a). The assistant threaded holes (400a) allow the cover (90) to be mounted securely to the assistant pivot pin (40a) by screws. The assistant pivot pin (40a) may have a structure same as the pivot pin (40) and has a protruding pintle, multiple second annular washers, a nut (43a) and a limit (44a) if the assistant connecting wall (23a) is same as the connecting wall as shown in FIG. 5. The assistant pivot pin (40a) may rotatably extend through the assistant riveting hole of the assistant connecting wall (22a) and has a protruding pintle, multiple second annular washers, a nut (43a) and a limit (44a).

The positioning ring (60) is mounted securely around the pivot shaft (30), is mounted between the enlarged end (32) and the upper bracket (20) and has multiple positioning protrusions (61). The positioning protrusions (61) correspond to the positioning slots (25) on the upper bracket (20) and detachably engage respectively with the positioning slots (25) to position the upper bracket (20).

The limiting ring (71) is mounted rotatably around the pivot shaft (30), is mounted between the lower bracket (10) and the upper bracket (20) and has an outer edge and a limiting tab (711). The limiting tab (711) is formed on the outer edge of the limiting ring (71) and has two ends. The two ends of the limiting tab (711) selectively contact the limiting protrusions (24) of the upper bracket (20) to limit the rotation of the upper bracket (20).

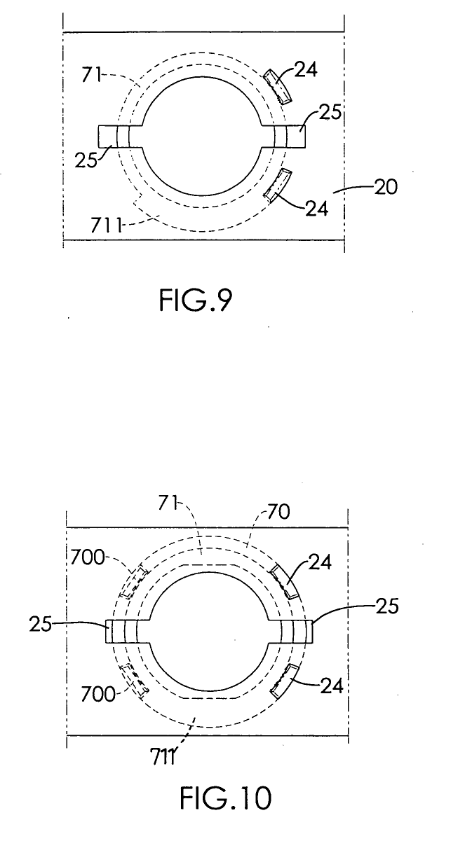

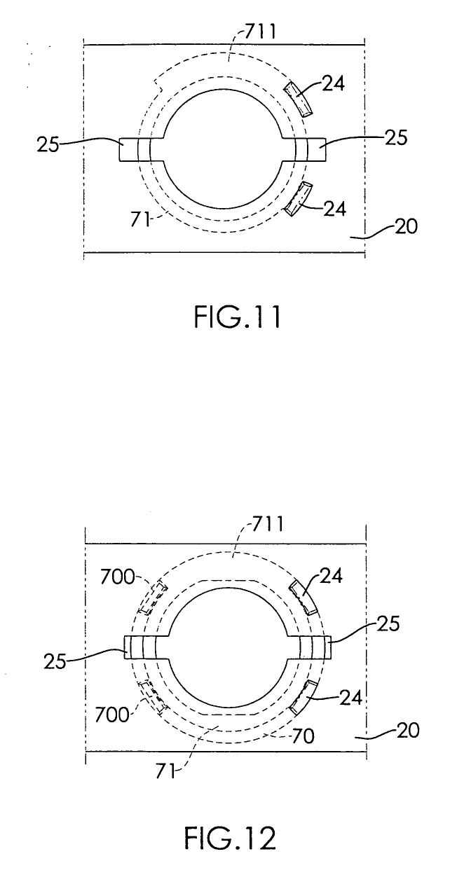

With further reference to FIGS. 9 to 12, the fastening ring (70) is mounted securely around the pivot shaft (30), is mounted between the lower bracket (10) and the limiting ring (71) and has an upper surface and two protrusions (700). The two protrusions (700) are formed on the upper surface of the fastening ring (70) and selectively contact the ends of the limiting tab (711). One limiting protrusion (24) contacts one end of the limiting tab (711) and drives the limiting tab (711) to rotate clockwise and relative to the fastening ring (70) when cover (90) rotates clockwise relative to the base (80) until one end of the limiting tab (711) contacts one protrusion (700) of the fastening ring (70) to limit the rotation in one direction. The other limiting protrusion (24) contacts the other end of the limiting tab (711) and drives the limiting tab (711) to rotate counterclockwise relative to the fastening ring (70) when cover (90) rotates counterclockwise relative to the base (80) until the other end of the limiting tab (711) contacts the other protrusion (700) of the fastening ring (70) to limit the rotation in the other direction

The cover (90) and the base (80) is able to rotate relative to each other when the angle between the cover (90) and the base (80) is at a specific angle and the protruding section, lower end (441), of the limiting (44) does not face the upper surface of the upper bracket (20). Thus, when the angle between the cover (90) and the base (80) is smaller than 90°, users know the cover can not be rotated at the first time, so the cover and the base does not wear each other.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A rotatable hinge comprising:
a lower bracket having
a central hole defined through the lower bracket;
an upper bracket mounted above the lower bracket and having
an upper surface;
two sides;
a central circular hole defined through the upper bracket and corresponding to the central hole of the lower bracket;
a connecting wall formed perpendicularly on one side of the upper bracket and having
an inner surface;
an outer surface; and
a riveting hole;
a pivot shaft mounted through the central hole of the lower bracket and the central circular hole of the upper bracket and having
a body protruding through the central hole of the lower bracket and the central circular hole of the upper bracket to allow the lower bracket to be mounted securely around the body and to allow the upper bracket to be mounted rotatably around the body; and
an enlarged end abutting the upper surface of the upper bracket;
a pivot pin rotatably extending through the riveting hole of the connecting wall and having
a protruding pintle rotatably extending through the riveting hole of the connecting wall and having
an end; and
an outer thread formed around the end of the protruding pintle;
a nut mounted around the protruding pintle and having an inner thread screwing with the protruding pintle; and
a limit mounted securely around the protruding pintle and having a protruding section being lower than and locking the enlarged end of the pivot shaft.

2. The rotatable hinge as claimed in claim 1, wherein
the protruding section has an lower end being lower than and locking the enlarged end of the pivot shaft when the lower end faces the upper surface of the upper bracket;
the limit further having
an upper end apposite to the lower end of the protruding section and being higher than the enlarged end of the pivot shaft;
two sides being higher than the enlarged end of the pivot shaft;
a riveting hole allowing the protruding pintle securely to protrude in;
a length between the upper end and the riveting hole;
two lengths between the sides and the riveting hole; and
a length between the lower end and the riveting hole being longer than the length between the upper end and the riveting hole and two lengths between the sides and the riveting hole.

3. The rotatable hinge as claimed in claim 1 further having multiple first annular washers mounted around the pivot shaft, wherein at least one of the first annular washers is mounted between the lower bracket and the upper bracket and the rest of the first annular washers is mounted between the enlarged end of the pivot shaft and the upper bracket.

4. The rotatable hinge as claimed in claim 1, wherein the pivot pin further has multiple second annular washers mounted around the protruding pintle, mounted adjacent to the inner surface and the outer surface of the connecting wall and the nut securely fastening the second annular washers around the protruding pintle.

5. The rotatable hinge as claimed in claim 1 further having a positioning ring securely mounted around the pivot shaft, mounted between the enlarged end and the upper bracket and having multiple positioning protrusions wherein
the upper bracket further has multiple positioning slots corresponding to the positioning protrusions and the positioning protrusions detachably engage respectively with the positioning slots.

6. The rotatable hinge as claimed in claim 1 further having
a limiting ring rotatably mounted around the pivot shaft, mounted between the lower bracket and the upper bracket and having
an outer edge; and
a limiting tab formed on the outer edge of the limiting ring and having two ends; and
the fastening ring securely mounted around the pivot shaft, mounted between the lower bracket and the limiting ring and having
an upper surface; and
two protrusions formed on the upper surface of the fastening ring and selectively contacting the ends of the limiting tab wherein
the upper bracket further has
a bottom surface; and
two limiting protrusions protruding from the bottom surface of the upper bracket, arranged in a circle being concentric with the central circular hole and selectively contacting the ends of the limiting tab on the limiting ring.

7. The rotatable hinge as claimed in claim 1 further having an assistant pivot pin wherein
the upper bracket further has an assistant connecting wall formed perpendicularly on the side of the upper bracket opposite to the connecting wall and the assistant pivot pin connects to the assistant connecting wall.

8. The rotatable hinge as claimed in claim 6, wherein two sides of the upper bracket are symmetrical and the assistant connecting wall has a structure same as that of the connecting wall having an assistant riveting hole; and
the assistant pivot pin is the same with the pivot pin, rotatably extends through the assistant riveting hole of the assistant connecting wall and has a protruding pintle, multiple second annular washers, a nut and a limit.
